(19) United States
(12) Patent Application Publication
(10) Pub. No.: US 2020/0170450 A1
(43) Pub. Date: Jun. 4, 2020

(54) KITCHEN DEVICE

(71) Applicant: Sara Miriam Goldson, Saint Louis, MO (US)

(72) Inventors: Sara Miriam Goldson, Saint Louis, MO (US); Gay Lee Freedman, Saint Louis, MO (US)

(21) Appl. No.: 16/628,670

(22) PCT Filed: Jul. 13, 2018
(86) PCT No.: PCT/US18/41979

§ 371 Date: Jan. 4, 2020

Related U.S. Application Data
(60) Provisional application No. 62/532,413, filed on Jul. 14, 2017.

(51) Int. Cl. A47J 45/10; B32B 5/26; B32B 7/027; B32B 9/02; B32B 9/04; B32B 15/14; B32B 27/12; B32B 27/36

(52) U.S. Cl. CPC A47J 45/10; B32B 2262/0276; B32B 7/027; B32B 9/02; B32B 9/041; B32B 9/047; B32B 15/14; B32B 27/12; B32B 27/36; B32B 2307/304; B32B 2307/726; B32B 2571/00; B32B 2255/02; B32B 2255/205; B32B 2262/062; B32B 5/26

(57) ABSTRACT

A device for holding high-temperature cookware and utensils is provided. The device allows for dissipation of heat, and prevents heat transfer to limbs and surface. The device may include a first outer layer, a second outer layer, and a middle layer. The first outer layer and second outer layer may be formed of an identical material. The material may be formed from cotton, terrycloth, dobby, linen, hemp or any other suitable material. The first and second outer layers may be formed from an absorbent towel-like material. The first and second outer layers may be stitched together.

### FIELD OF TECHNOLOGY

The present invention relates generally to a kitchen apparatus. More specifically, the present invention relates to an apparatus for gripping and handling of hot items.

### BACKGROUND

Conventional kitchen accessories include a dishtowel, kitchen glove, potholder or oven mitt for gripping or holding high-temperature utensils, such as cookware, kitchen utensils and the like. The utensils and/or cookware are typically handled with a kitchen glove or oven mitt directly from a hot oven or stove, or any similarly suitable product, such as a barbecue grill.

While typical dishtowels are Ubiquitous, they are often made of a thinner material, which is not heat absorbent. The typical dishtowel does not prevent heat from seeping through, and therefore, its use may result in burning or dropping the cookware or utensils being held. Specifically, when a dishtowel and/or hand(s) are wet, which is commonplace in a kitchen, the dishtowel/hand(s) may further transfer heat to a hand or arm holding the dishtowel, causing severe and painful burns. Moreover, it is difficult to insert wet hands into kitchen gloves, potholders or oven mitts.

Alternatively, efforts have been made to avoid heat transfer by folding over the cloth. This method is inefficient and dangerous. Specifically, in some instances, even doubling over the dishtowel will not be sufficient to prevent heat transfer. In certain cases, this process may be dangerous, as the folds cause crevices that cause a catching of the handle, resulting in slippage or spillage of the high-temperature utensil.

A typical potholder, such as one formed of fabric, works with only one hand at a time, providing space for receiving only one hand. Therefore, a typical pot holder requires two potholders in order to use two hands to hold a high-temperature device. Additionally, a fabric potholder, when damp or wet, transfers heat from cookware or utensils to a user's hand, thereby increasing the risk of burns. Similar risks of burning can be found in kitchen gloves, dishtowels oven mitts, potholders and the like. Specifically, the hand(s) may become trapped in kitchen glove(s) or hand mitt(s) from a hot spill on the hand(s), causing severe and painful bums.

Some potholders, such as silicone potholders, also work with only hand. Additionally, the silicone potholders may be heavy and cumbersome, and difficult to store. Silicone potholders are also difficult to clean, making them undesirable to be stored in plain sight.

Oven mitts and other accessories fail to address these issues, and may be difficult and awkward to put on. They are often formed in one size fits all, and are not particularly flexible. Thus, oven mitts limit dexterity while being worn. The oven mitts therefore do not provide for a user to comfortably move a hand while wearing the mitts. Oven mitts require two gloves, and also limit dexterity. Further, such oven mitts are difficult to put on and remove when hands or oven mitts are damp or wet, leading to burning if coming into contact with a hot liquid.

It would be desirable, therefore, to provide a device for holding high-temperature cookware or utensils. It would be further desirable to provide a device that dissipates heat and prevents transfer of heat to a limb. It would be further desirable to provide a device that dissipates heat and prevents transfer of heat to a surface such as a countertop, which might burn, mar, or shatter the table surface.

It would be yet further desirable to provide a device for use with either one or two hands. It would be yet further desirable to provide a device that is machine washable and dryable, and is also aesthetically pleasing. It would be yet further desirable to provide a device that provides agility and dexterity to the wearer and accommodates any user. It would be yet further desirable to provide a device that can be used when the device or hand(s) are wet or dry with high-temperature cookware or utensils, with a decreased fear of burning or spilling. It would be yet further desirable to provide a device that may be used as a trivet to be placed under a hot pot, kettle or serving dish to protect a surface underneath. It would be further desirable to provide a device that is usable with wet hands, and/or when a dishtowel is wet.

### SUMMARY OF THE INVENTION

A device for holding high-temperature cookware and utensils is provided. The device may be used in a kitchen as a kitchen glove, oven mitt, kitchen towel or dishtowel, potholder or any other suitable need (referred to herein as “the device”).

The device allows for dissipation of heat, and prevents heat transfer to limbs and surface. The device may be used with one hand, and may be utilized when the device and/or hand(s) are wet without fear of burning.

In accordance with an embodiment, the device may include a first outer layer, a second outer layer, and a middle layer. The first outer layer and second outer layer may be formed of an identical material. In an embodiment, the material may be formed from cotton, terrycloth, dobby, linen, hemp or any other suitable material. The first and second outer layers may be formed from an absorbent towel-like material. The first and second outer layers may be stitched together.

The middle layer may be formed of a heat absorbent, heat reflective, heat deflective, or heat resistant material. The middle layer may be wholly enclosed between the first and second outer layers. In an embodiment, the middle layer may be formed from a plurality of layers.

### BRIEF DESCRIPTION OF THE DRAWINGS

FIG. 1 illustrates an exemplary device in accordance with an embodiment of the invention.

FIG. 2 illustrates an exemplary view of the various components of the device in accordance with an embodiment.

FIG. 3 illustrates another view of the various components of the invention.

FIG. 4 illustrates another embodiment of the device as shown in FIG. 1.

FIG. 5 illustrates another embodiment of the device as shown in FIG.

FIG. 6 illustrates another embodiment of the device as shown in FIG. 3,

FIG. 7 illustrates another embodiment of the device as shown in FIG. 2.

### DETAILED DESCRIPTION OF THE INVENTION

Disclosed herein is a device for use in gripping and holding hot items.

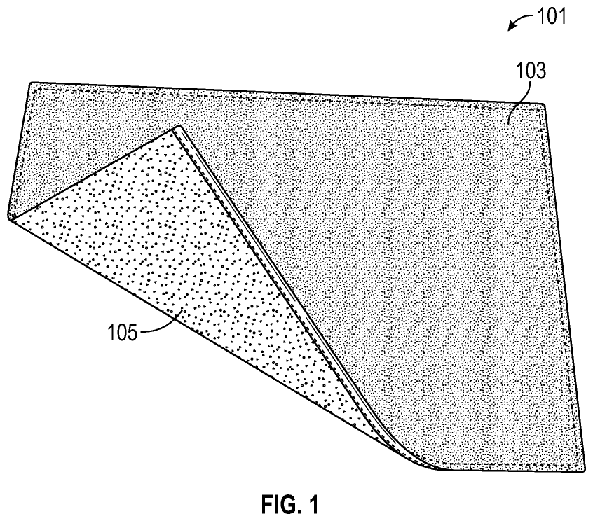

Referring now to FIG. 1, in an embodiment, the device 101 is formed of a first outer layer 103 and a second outer layer 105. Outer layer 103 is formed of a first material, such as towel-like material, which is an absorbent fabric usually formed of cotton. Any suitable towel-like material may be used, including, but not limited to, cotton or microfiber, linen, hemp, dish toweling, terrycloth, dobby, linen, hemp, cotton linen, cotton-blend, or any other suitable material. Outer layer 105 may be formed from a second material. The second material may be different from the first, and for example, may be a terrycloth type material, or any other suitable towel-like material. One or both of outer layers 103 and 105 may be water/liquid absorbent. In an exemplary embodiment, outer layers may be formed of material with 225 grams per square meter (denoted as “g/sm”) weight. In another embodiment, the weight may be between 200-300 g/sm, though any other suitable weight is contemplated.

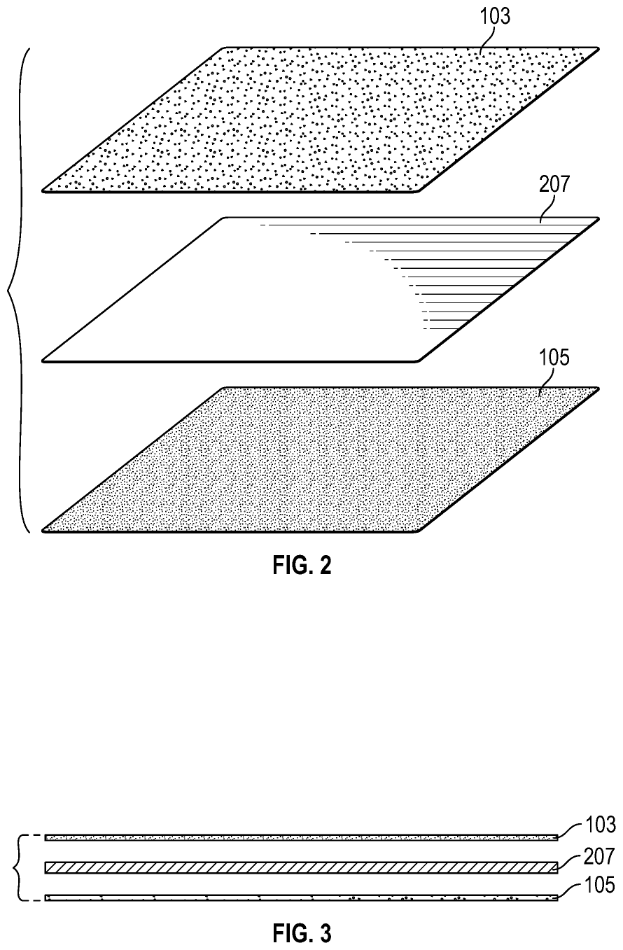

Between outer layers 103 and 105, not shown in FIG. 1, is a heat resistant, heat absorbent, heat reflecting, or heat deflecting sheet, referred to as a heat layer 207. Heat layer 207 is illustrated in FIG. 2.

Heat layer 207 may be formed of any suitable material for insulating heat, deflecting heat, reflecting heat and/or retaining heat, such that heat contacting a first side of the device (for example, outer layer 103) is absorbed by, and not transferred to, the second side of the device (for example, outer layer 105). Thus, heat layer 207 functions as a lining/barrier, for insulating a hand or hands that may be using the device to hold or handle a hot kitchen item.

In an embodiment, heat layer 207 may be formed of a batting material blend. In an embodiment, an exemplary composition of the heat layer is a cotton-backed fabric, with a metallized coating bonded to the fabric. In another embodiment, an exemplary blend includes greater than 90% polyester, and between 5-10% metalized polyester. In a further example, mylar coating may be woven into the outer layer. The heat layer 207 may be formed of a double sided hollow polyester fiber, with a metallicized polyester center. In another embodiment, a suitable layer may be formed using ThemaFlee, or any other suitable variation of ThermaFlec, Insul-Bright or any other type.

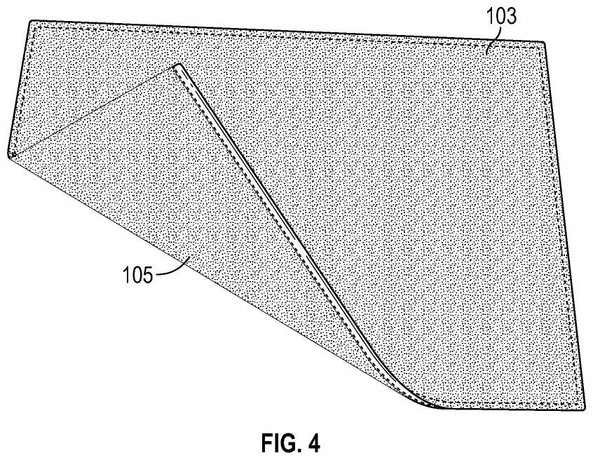

In one embodiment, the heat layer 207 is formed by folding a double layer of the heat layer, such that it is folded over itself. This feature is illustrated in FIG. 4. In an embodiment, one layer of heat layer 207 is formed of the metallic coating on one side and a cotton or cotton-type coating on the second side. When a double heat layer 207 is formed, each heat layer's cotton layer face inwards toward one another, with each heat layer's metallic layer facing away from the other.

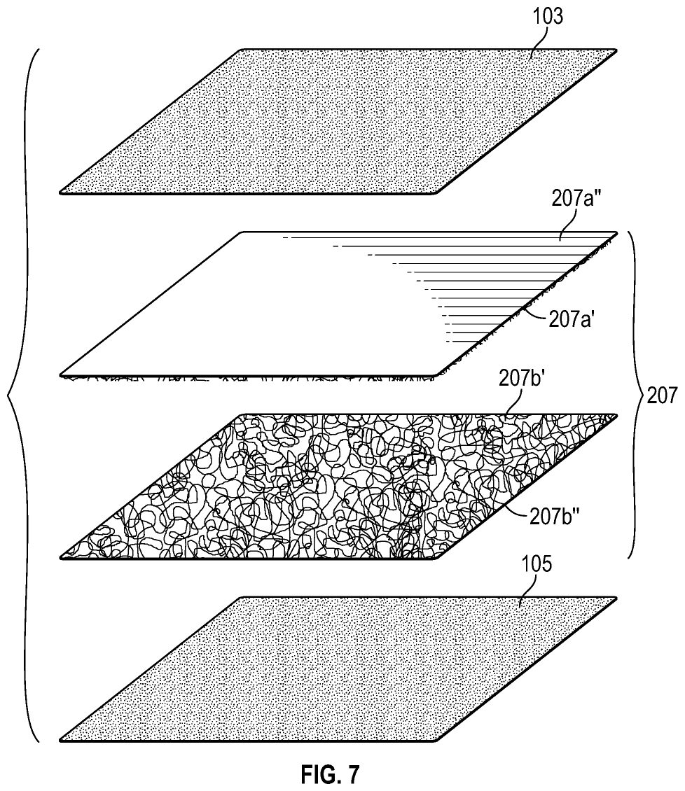

With further reference to FIG. 7, heat layer 207 may be formed of two layers. The two layers may be layered one on top of the other. As illustrated in FIG. 7, heat layer 207 may be formed of heat layers 207a and 207b. Heat layer 207a includes metallic side 207a′ and cotton side 207a″, with heat layer 207b formed in a mirror image, with metallic side 207b′ and cotton side 207a″. in an embodiment, the two layers 207a and 207b may be coupled to or bonded with one another.

Referring back to FIG. 1, the first and second outer layers may be stitched or bonded together with stitching 109. The first and second outer layers may therefore fully enclose heat layer 207.

Thus, in accordance with the invention, the device allows a user, such as an individual holding, for example, a heated pot with the device, to safely hold high-temperature cookware.

In accordance with an embodiment, the inventive device may be utilized with one hand or two hands. Thus, the device only requires one device to utilize two hands with high-temperature cookware or utensils. In one embodiment, the device may be machine washable. The device may also be machine dryable.

The inventive device therefore provides for increased agility and dexterity. The device is flexible, and provides a receiving space for a hand, or a plurality of hands, of any size. Thus, the device provides for increased mobility of a user's hand or hands.

Referring now to FIG. 3, illustrated is an embodiment of the device 101 in a cross-sectional view. Shown are the two outer layers 103 and 105, which fully enclose the heat layer 207. In an alternative embodiment, both outer layers may form a pocket around the heat layer.

In an exemplary embodiment, quilting may be formed on one or more of outer layers 103 and 105. In an embodiment, the quilting may be formed in a chevron or curved pattern, and may be formed the width of the outer layer. In an embodiment, the quilting may be formed of any pattern, or no pattern at all.

In accordance with an embodiment, the device does not require a hand or hands to be inserted for use. The device allows for a user to place a hand or hands in any location within the device, and to grip cookware, utensils or any other high-temperature device at any location on the cookware or utensil. The device may be easily stored.

In accordance with the invention, the device provides flexibility for using either one or two hands. Thus, when one hand is removed from the device, the high-temperature cookware or utensil can still be held by the other hand. The device may be further utilized as a protective device for a table, countertop, or any other surface. The device is adaptable, for example to be used as a trivet, and can be spread beneath cookware, such as a pot, pan, or dish. In an exemplary embodiment, the device provided for the ability to hold a casserole dish and oven rack that had been baked at 350-550 degrees for at least thirty seconds.

FIG. 4 illustrates an embodiment of the device as illustrated in FIG. 1, with both outer layers 103 and 105 formed of identical material.

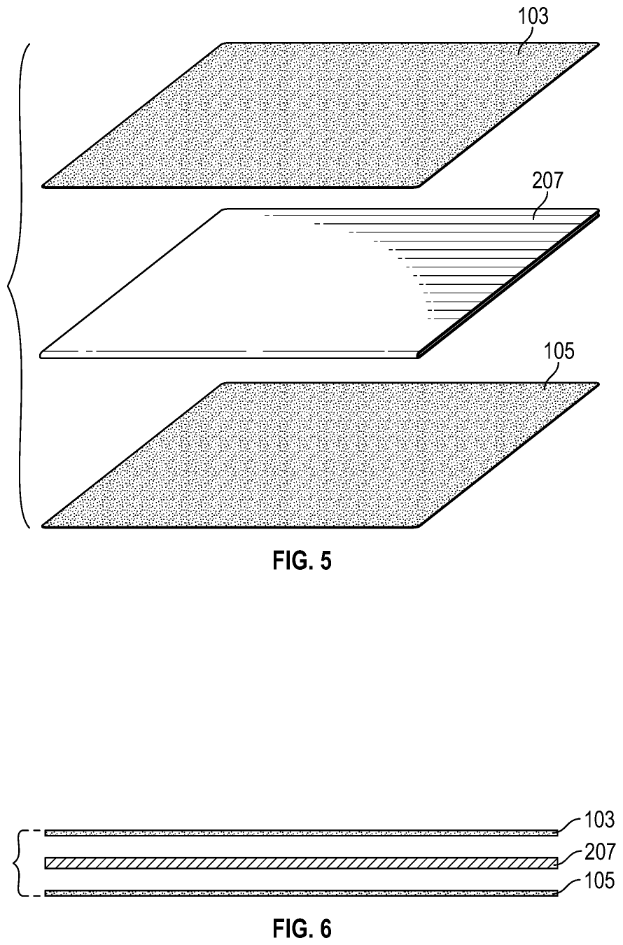

FIG. 5 illustrates an embodiment of the device as illustrated in FIG. 2, with identical outer layers. Additionally, FIG. 5 illustrates heat layer 207, folded over. In another embodiment, heat layer 207 may be formed of two layers of insulating material. Identical layers may be used, but the two heat layers 207 may also be of different properties.

FIG. 6 illustrates an embodiment of the device as illustrated in FIG. 3, with identical outer layers.

FIG. 7, as discussed above, illustrates an embodiment wherein the heat layer 207 is formed of two layers.

Although the description above contains many specifics, these should not be construed as limiting the scope of the invention but as merely providing illustrations of some of the presently preferred embodiments of this invention.

Thus the scope of the invention should be determined by e appended claims and their legal equivalents, rather than by the examples given.

What is claimed is:

1. A device comprising:
a first outer layer;
a second outer layer; and
a middle layer, the middle layer forming a heat absorbent layer.

2. The device of claim 1, wherein the heat absorbent layer is a first heat absorbent layer, the middle layer further comprising a second heat absorbent layer.

3. The device of claim 2, wherein the first and second heat absorbent layers comprise one side cotton and one side metallic material.

4. The device of claim 2, wherein the first heat absorbent layer is folded over the second heat absorbent layer.

5. The device of claim 1, wherein the first outer layer and the second outer layer are formed from identical material.

6. The device of claim 1, wherein the first outer layer and the second outer layer are formed from different materials.

7. The device of claim 1, wherein the first outer layer is formed of an absorbent towel material, and the second outer layer is formed of a terrycloth material.

8. The device of claim 1, wherein the first outer layer and the second outer layer form a pocket around the middle layer.

9. A device comprising:
a first outer layer;
a second outer layer; and
a heat absorbent layer adapted to insulate between the first outer layer and the second outer layer.

10. The device of claim 9, wherein the first outer layer and the second outer layer are formed from identical material.

11. The device of claim 9, wherein the first outer layer and the second outer layer are formed from different materials.

12. The device of claim 9, wherein the first outer layer is formed of an absorbent towel material, and the second outer layer is formed of a terrycloth material.

13. The device of claim 9, wherein the middle layer is formed of a double layer.

14. The device of claim 9, wherein the first outer layer and the second outer layer form a pocket around the middle layer.
